(19) United States
(12) Patent Application Publication
(10) Pub. No.: US 2016/0071420 A1
(43) Pub. Date: Mar. 10, 2016

(54) DO-NOT-FLY AND OPT-OUT PRIVACY MANAGEMENT SYSTEM FOR UNMANNED AERIAL VEHICLES

(71) Applicant: Appareo Systems, LLC, Fargo, ND (US)

(72) Inventor: Joseph A. Heilman, Fargo, ND (US)

(21) Appl. No.: 14/850,669

(22) Filed: Sep. 10, 2015

Related U.S. Application Data
(60) Provisional application No. 62/048,685, filed on Sep. 10, 2014.

(51) Int. Cl. G08G 5/00

(52) U.S. Cl. CPC G08G 5/006; G08G 5/0034; G08G 5/0069

(57) ABSTRACT

An opt-out privacy management system for an unmanned aerial vehicle flight planning application, comprising an internet-based user input device, an internet-based opt-out request management application, and an internet-based do-not-fly database application in communication with an existing, external aircraft safety system, wherein a user can enter a property opt-out request into the user input device, which sends the property opt-out request to the do-not-fly database application, and the do-not-fly database application communicates the property opt-out request to the at least one existing, external aircraft safety system.

### CROSS REFERENCE TO RELATED APPLICATIONS

This application claims priority in U.S. Provisional Application No. 62/048,685, filed Sep. 10, 2014 and entitled “UNMANNED AERIAL AGRICULTURAL VEHICLES,” which is incorporated herein by reference. The following related applications are also incorporated herein by reference: U.S. patent application Ser. No. 14/850,564, filed Sep. 10, 2015 and entitled “AUTOMATED FLIGHT CONTROL SYSTEM FOR UNMANNED AERIAL VEHICLES;” and U.S. patent application Ser. No. 14/850,636, filed Sep. 10, 2015 and entitled “AERIAL INFORMATION REQUEST SYSTEM FOR UNMANNED AERIAL VEHICLES.”

### BACKGROUND OF THE INVENTION

1. Field of the Invention

This invention relates generally to the field of aviation, and specifically to a do-not-fly and opt-out privacy management system for unmanned aerial vehicles.

2. Description of the Related Art

In terms of unmanned aerial vehicles, or UAVs, the current state-of-the-art is generally driven by recent innovations in the model aircraft hobby industry. Almost all systems on the market today employ some primitive form of flight control system and airframe technology found in the hobby industry. While the pricing of total systems vary widely, these systems still generally resemble hobby-level materials. Electronic solutions for these aircraft (such as a simple flight control system, autopilot, radio communications, power systems, sensors/imagers, antennas, etc.) usually consist of a mix of off-the-shelf modules patched together with wiring.

The willingness of companies to invest in the development of these systems and the ability for consumers to utilize them has been substantially deterred in the United States by a lack of clarity and regulation definition by the United States Federal Aviation Administration (FAA). Technology developers and consumers of these systems are operating these systems under guidelines published by the Academy of Model Aeronautics' (AMA), as well as the FAA's Special Rule for Model Aircraft (in section 336 of the FAA Modernization and Reform Act of 2012). The FAA has changed its interpretation of this rule several times in the past several years, causing even more hesitancy to invest in and market new technologies. Today, to operate under model aircraft rules, the aircraft and operator must meet certain criteria as outlined below:
The operator must maintain a visual of the aircraft, in line of sight, with an unaided eye
The aircraft should not fly over populated areas
The aircraft is flown strictly for hobby or recreational use
The aircraft is operated in accordance with a community-based set of safety guidelines and within the programming of a nationwide community-based organization (that is, the AMA)
The aircraft is limited to not more than 55 pounds unless otherwise certified through a design, construction, inspection, flight test, and operational safety program administered by a community-based organization
The aircraft is operated in a manner that does not interfere with and gives way to any manned aircraft
When flown within 5 miles of an airport, the operator of the aircraft provides the airport operator and the airport air traffic control tower with prior notice of the operation.

While the industry today seems comfortable operating under the guidelines of a model aircraft, the FAA also released a table of examples of flying a model aircraft for recreational or personal use. See the example below:

| Hobby/Recreation | Not Hobby/Recreation |
|---|---|
| Flying a model aircraft at the | Receiving money for demonstrating |
| local model aircraft club. | aerobatics with a model aircraft |
| Taking photographs with a model | A realtor using a model aircraft |
| aircraft for personal use. | to photograph a property that he is |
| | trying to sell and using the photos |
| | in the property's real estate |
| | listing. A person photographing a |
| | property or event and selling |
| | the photos to someone else. |
| Using a model aircraft to move | Delivering packages to people |
| a box from point to point without | for a fee. |
| any kind of compensation. | |
| Viewing a field to determine | Determining whether crops need to |
| whether crops need water when | be watered that are grown as part |
| they are grown for personal | of a commercial farming operation. |
| enjoyment. | |

The FAA is seeking technologies that would help them regulate and certify aircraft systems to operate safely in the airspace. They are looking to the recently formed national test sites to help in this endeavor. Originally, the FAA had set a goal of having the rules defined by 2015, but has recently announced that it will not reach that goal and now estimates a 2016 date. They have, however, indicated that it may potentially issue certain exemptions for particular industries/interest groups with limited operations. Those areas include: agriculture, pipeline/power line inspection, and film. They have not given any hints as to the potential issuance timeframe of these exemptions, nor what they might include.

In addition to waiting for definition of the regulations, other forces must be considered in the operation of unmanned aerial vehicles. UAVs must be able to coexist with manned aircraft without creating situations that put human lives in jeopardy. If UAVs can be tied into the same safety systems being implemented for manned aircraft, allowing the exact position of a UAV to be known and broadcast to other aircraft, most dangerous situations could be avoided.

In addition to general safety concerns, the increased number of flights of UAVs can pose a threat to the privacy of individuals. The ideal UAV management system should allow individuals to protect their property from unwanted fly-overs, by designating their property as a “do-not-fly” zone.

What is needed in the art is an unmanned aerial vehicle solution which has a state-of-the-art automated flight control system which implements the tracking and safety systems in place for manned aircraft while adding safety features and redundancy to compensate for the lack of a local, on-board pilot/operator, one or more airframe designs capable of fulfilling various missions, fixed base (ground) stations which allow for UAV docking, recharge or refuel, and communication, sensor packages which can be easily swapped out or adapted to new missions, and a cloud-based infrastructure that will support information requests, flight planning, and the creation and management of geographic regions where further restrictions can be applied to any UAVs which enter those zones.

### SUMMARY OF THE INVENTION

According to one aspect of the present invention, an opt-out privacy management system for an unmanned aerial vehicle flight planning application is described, comprising an internet-based user input device, an internet-based opt-out request management application, and an internet-based do-not-fly database application in communications with an existing, external aircraft safety system, wherein a user can enter a property opt-out request into the user input device, which sends the property opt-out request to the do-not-fly database application, and the do-not-fly database application communicates the property opt-out request to the at least one existing, external aircraft safety system.

This aspect and others are achieved by the present invention, which is described in detail in the following specification and accompanying drawings which form a part hereof.

### BRIEF DESCRIPTION OF DRAWINGS

The drawings constitute a part of this specification and include exemplary embodiments of the invention illustrating various objects and features thereof, wherein like references are generally numbered alike in the several views.

FIG. 1 is a block diagram of one embodiment of an automated flight control system for an unmanned aerial vehicle.

FIG. 2 is a functional block diagram of an aerial information request system for managing the attainment of information on a location using an unmanned aerial vehicle.

FIG. 3 is a functional block diagram of an opt-out privacy management system that allows landowners to mark their property as a “do-not-fly” zone in order to prevent unauthorized flyovers of the property.

### DETAILED DESCRIPTION OF THE PREFERRED EMBODIMENT

### I. Introduction and Environment

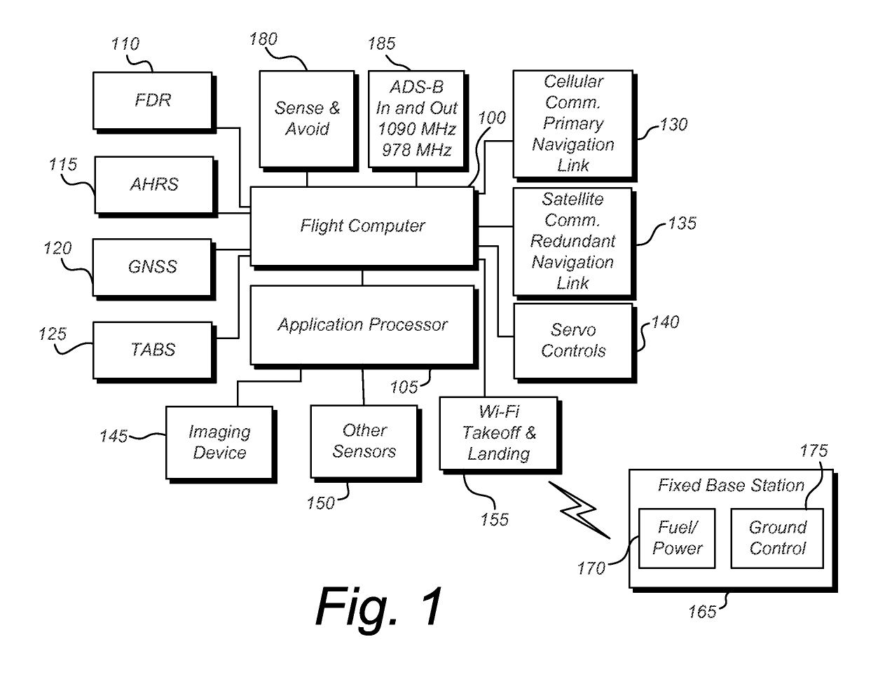

With reference now to the drawings, and in particular to FIGS. 1 through 3 thereof, a new aerial information request system for unmanned aerial vehicles will be described.

In this document, references in the specification to “one embodiment”, “an embodiment”, “an example”, “another embodiment”, “a further embodiment”, “another further embodiment,” and the like, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to affect such feature, structure, or characteristic in connection with other embodiments whether or not explicitly described.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In order to realize the preferred embodiment of the unmanned aerial vehicle solution of the present invention, the following components must be realized:
A state-of-the-art automated flight control system which implements the tracking and safety systems in place for manned aircraft while adding safety features and redundancy to compensate for the lack of a local, on-board pilot/operator
One or more airframe designs capable of fulfilling various missions
Fixed base stations (also known as ground stations) which allow for UAV docking, recharge or refuel, and communication and data exchange with a base station
Sensor packages which can be easily swapped out or adapted to new missions
A cloud-based infrastructure that will support information requests, flight planning, and the creation and management of geographic regions where further restrictions can be applied to any UAVs which enter those zones, such as “do not fly” zones.

These items will be discussed in additional detail in the following sections, with reference to FIGS. 1-3.

Automated Flight Control System: A certified electronic control system for the commercial use of UAVs does not exist today. A device of this nature would be an enabling piece of technology that manufacturers and systems providers would readily adapt. FAA certification of such a control system would be crucial for optimizing the adoption and use.

### II. Preferred Embodiment

Turning now to FIG. 1, we see a block diagram of one embodiment of an automated flight control system (AFCS) for an unmanned aerial vehicle. The ideal AFCS would have the firmware necessary to enable the control of many different types of airframes (fixed wing, multi-rotor, VTOL wings, etc.) This allows for a very flexible system that would appeal to manufacturers of airframes looking for an FAA-certified control system.

In the embodiment shown in FIG. 1, the AFCS would incorporate a flight computer 100, responsible for controlling the major flight components and communication modules for the aircraft. The flight components and communication modules shown in FIG. 1 are intended to be exemplary only and not limiting in any way, but will provide an illustration of the types of functionality required for a sufficiently safe and redundant system that can coexist in the same airspace with piloted aircraft.

A flight data recorder (FDR) 110 would allow aspects of the flight (such as location, sensor readings, control structure positions, commanded actions, etc.) to be recorded so that they can be used for post-flight analysis or in the event of an aircraft malfunction.

An attitude and heading reference system (AHRS) 115 that provide aircraft attitude information, typically including heading, pitch, roll, and yaw. The AHRS 115 may be implemented using a high quality inertial measurement unit (IMU) comprising gyroscopes, accelerometers, and magnetometers, but any appropriate technology may be used for the AHRS 115.

In order to provide geographic location information, the AFCS will have a global navigation satellite system (GNSS) receiver 120. A GNSS receiver 120 can receive signals from multiple geosynchronous satellites orbiting the Earth and use the differences detected in the phases of the various signals to triangulate and calculate a three-dimensional geospatial position. A typical GNSS system in use today is the Global Positioning System (GPS), which is well-known in the art.

A traffic awareness beacon system (TABS) module 125 may be included as a means of providing a standard for low-cost surveillance for certain aircraft types. The intent of TABS 125 is to make an aircraft carrying the TABS 125 to be visible to other aircraft that are equipped with collision avoidance systems such as TAS, TCAS I, TCAS II, and ADS-B In. TABS 125 may also be referred to other names, such as low powered surveillance equipment (LPSE) or light aircraft surveillance equipment (LASE).

The AFCS may have an ADS-B module 185. ADS-B stands for automatic dependent surveillance—broadcast and it is a cooperative surveillance technology in which an aircraft determines its position via satellite navigation and periodically broadcasts it, enabling the aircraft to be tracked or to identify itself to other aircraft and ground-based stations equipped with ADS-B transceivers. The ADS-B module 185 may be used by or in conjunction with the TABS module 125, or with the Sense & Avoid module 180, to help keep the aircraft safe.

The sense & avoid module 180 will allow the aircraft to communicate with other aircraft enabling the concept of “self-separation” of the aircraft, where aircraft are equipped with modules designed to transmit to and receive from similar equipment on other aircraft, allowing two or more aircraft in proximity to make recommendations to pilots or to control the aircraft directly to move them away from each other automatically. A sense & avoid function 180 created today would likely be based on the ADS-B system described in the previous paragraph, but any appropriate self-separation technology could be used.

A critical piece of the AFCS will be a multi-modal communication system incorporating Wi-Fi communications 155, cellular communications 130, and satellite communications 135. These modules would be used for data transfer and communication with a fixed base station 165. In one embodiment, typical usage of these communications modules may be as follows:
The Wi-Fi module 155 may be used to establish communications with the fixed base station 165 in order to coordinate takeoff and landing procedures. For example, a rotary-wing aircraft (such as a remotely-pilot quad-copter) could communicate with the base station 165 when coming in for a landing to coordinate position and deceleration to affect a good landing.
The cellular communications module 130 may be used as the primary communications link for sending and receiving navigation commands from a remote operator or remote system. The cellular communication module 130 could act as a back-up system for takeoff and landing, as well, in case the Wi-Fi link 155 is lost.
The satellite communications module 135 may be used as the backup or redundant communications link for sending and receiving navigation commands from a remote operator or remote system. The satellite communication module 135 could act as a back-up system for takeoff and landing, as well, in case the Wi-Fi link 155 is lost and the cellular communications module 130 is not working.

Finally, the flight computer 100 could manage a servo controls module 140, responsible for controlling the position and angle of each of the aircraft's control surfaces for flight.

In addition to the flight computer 100, the AFCS may offer an applications processor 105. The applications processor 105 and the flight computer 100 may actually be implemented as separate functions on a single physical processor, or the two functions may be implemented on separate processors for redundancy. The application processor 105 would be responsible for managing the aircraft functions that are not related directly to flight, such as an imaging device 145 (such as a camera or spectrometer) or any of a number of other sensors 150 used for collecting information during a flight.

The AFCS will have inputs for a variety of sensors depending on the requirements of the application. Data analysis will typically not be processed, in its entirety, by the AFCS. Rather, data will be offloaded automatically (via the Wi-Fi module 155 in some embodiments) when the aircraft returns to the fixed base station 165. Sufficient on-board memory (not shown in FIG. 1 but assumed to be resident functionally in the blocks shown) may be required in either the AFCS or the sensors 150 themselves to store captured data.

While the AFCS will not perform the bulk of the data processing required to derive actionable information, the AFCS may need to be able to analyze a real-time feed from the sensors 150 to perform any activities requiring that the aircraft respond immediately. This “sense & respond” technology would allow the aircraft to check the sensor output (an image for example) for a specified condition (perhaps a field fire, or an animal with low body temperature). If the condition is met, the aircraft will utilize an appropriate communication methodology to send an alert immediately to the fixed base station 165 and, ultimately, to a human or automated system so that action may be taken.

The fixed base station 165 itself may act as a landing pad or docking station for the aircraft. As such, it may be required to have fuel and/or a charging station 170 to make sure the aircraft is ready to go for the subsequent mission. The fixed base station 165 will likely also have a ground control function 175, allowing the base station 165 to automatically control or communicate with an aircraft, or to allow a human operator to do so. The ground control function 175 may also allow software updates and data transfers (such as updated maps, new applications, etc., as well as the download of data from the aircraft). The fixed base station 165 may itself be tied into a network of other base stations 165, to a remote system, or to the internet or other cloud-based system.

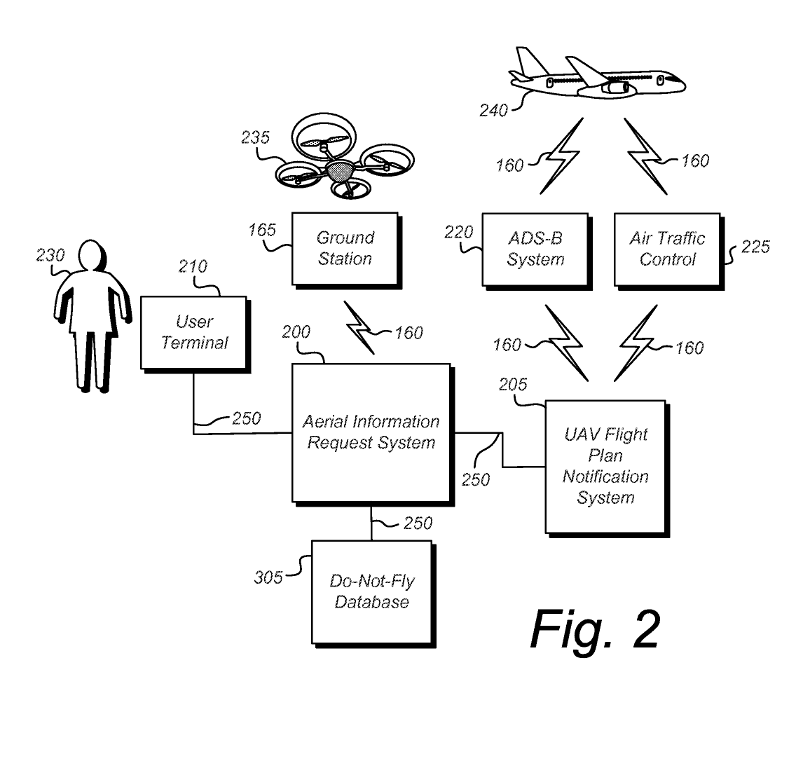

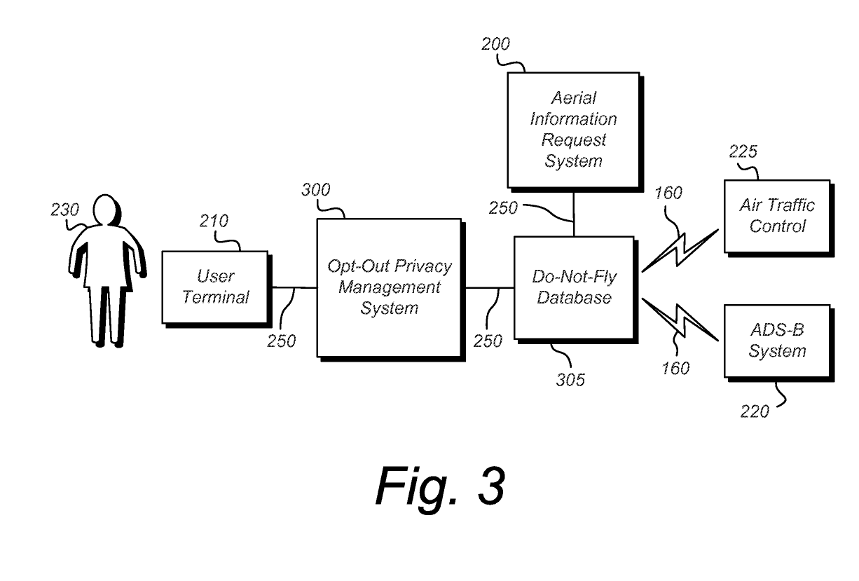

Perhaps one of the most important considerations in an effective UAV system is the handling of information requests and the subsequent flight planning involved. Today, in order to make aerial sensor data valuable, it must typically be processed by several different software systems and manually edited or manipulated. This process is not very efficient or user-friendly and is prone to error. In addition, UAV flights to gather such data must be carefully integrated in with piloted flights in the same or nearby airspace. These data management and integration functions can be handled by the systems described in FIGS. 2 and 3.

Ideally, the data collected by a UAV would be automatically processed and turned into information that can be acted upon with very little user action or input required. Also, an owner of an unmanned agriculture system should not have to sit and wait for the right conditions to operate an aircraft and collect data. Generally, when the conditions are perfect for collecting aerial data, the farmer would likely want to do other things as well (spray, apply fertilizer, harvest, etc.)

Turning now to FIG. 2, we see a functional block diagram of one embodiment of an aerial information request system for managing the attainment of data/information on a location using a UAV. An operator 230 (a farmer or agronomist, for example) begins by telling the aerial information request system (AIRS) 200 that information is needed for one or more specific fields on or by a certain date.

This would be considered a Request for Information, which would be an input to the AIRS 200. The AIRS 200 could then analyze weather forecasts, available flight traffic information, no-fly zones, and other conditions or scenarios necessary for the flight. Some of this information would come from a dedicated do-not-fly database 305, which would contain information on geographical regions that are currently designated as “do-not-fly” zones. Additional detail on the do-not-fly database 305 is given in the discussion of FIG. 3 later in this specification. Other information may be gathered from a UAV flight plan notification system 205, which will have ties to existing external systems including (but not limited to) the national ADS-B system 220 and various air traffic control systems 225. The UAV flight plan notification system 205 will communicate to these systems via an appropriate wireless communications protocol 160, and these systems (the ADS-B system 220 and air traffic control 225) will in turn talk to piloted aircraft 240 and UAVs 235 via a similar wireless protocol 160. The UAV flight plan notification system 205 will obtain information on other aircraft in the area, weather reports, etc., from systems 220, 225, and other appropriate systems, and share that information as appropriate with the AIRS 200.

If it is deemed, by the AIRS 200, appropriate and safe to perform the mission, the AIRS will plan a flight path for an available UAV 235 (in accordance with no-fly zones and air traffic information) and alert the requestor 230 of information on the planned flight. The requestor 230 will approve the plan and the AIRS 200 will “post” its plan to the UAV Flight Plan Notification System 205, which will in turn make the flight plan information known to the air traffic control 225 and ADS-B system 220. The requestor 230 will be alerted when the flight has started, if any issues arise, and when the flight has completed and the aircraft has returned to the fixed base station 165.

The UAV Flight Plan Notification System 205 will be utilized by air traffic control 225 and ADS-B compliant systems 220 to notify any incoming manned aircraft 240 that a UAV 235 may be in or near their flight path.

When the mission of the UAV 235 is completed, the onboard sensor data will then be downloaded by the fixed base station 165 and subsequently uploaded to the AIRS 200 by wireless transfer 160. When the operator 230 accesses the software (a cloud based system in the preferred embodiment), the data has been consolidated, stitched together, geo-rectified, processed, analyzed, etc. It is now considered information that can be utilized by a farm management system to employ the appropriate technique for the specific operation (fertilizer application, herbicide application, harvesting efficiencies, etc.).

In essence, the AIRS 200 combines flight planning and control software and data post-analysis software into one system. It could possibly be utilized by other data collection systems not controlled by the AFCS.

A major concern of the general public in regard to UAVs is the matter of privacy. To quell this concern, a Do-Not-Fly database and Opt-Out Privacy Management System would be developed. FIG. 3 is a functional block diagram of an opt-out privacy management system that allows landowners to mark their property as a “do-not-fly” zone in order to prevent unauthorized flyovers of the property.

A do-not-fly database 305 would contain an up-to-date, geo-referenced list of locations, airspaces, and geometries where it would be prohibited to fly (airports, municipalities, towers, etc.) Compliance with and the integration of this system would be mandatory for the certification of the AFCS or competitive products.

In one embodiment, an opt-out privacy management system 300 would be a public website that would allow citizens, who do not want a UAV to fly over their land, to validate proof of ownership and mark the areas of land that they do not want unmanned aircraft entering. Once validated, these areas would then be entered into the do-not-fly database 305 and, before each mission, the AIRS 200 would check its flight plan against the do-not-fly database 305 and create new flight plans accordingly.

Individuals could, however, grant permission to owners of UAVs, or particular UAVs, to fly over their land using the opt-out privacy management system 300. This would allow for landowners to allow their neighbors to plan flights over their land, or to allow flights over their land for other purposes.

Looking at FIG. 3, a typical opt-out scenario may work as follows. A system user 230 would access the system through a user terminal 210, which may be a personal computer or a mobile computing device. The opt-out request would be sent from the user terminal 210 over an internet connection 250 to the opt-out privacy management system 300, which would like reside on the cloud/internet as a service webpage. The opt-out privacy management system 300 would process and validate the request, and send it over an internet connection 250 to a do-not-fly database 305. The do-not-fly database 305 would be updated accordingly, and this newly defined no-not-fly zone would be made available to the AIRS 200, as well as transmitted over a wireless connection 160 to external systems, including any air traffic control systems 225 and the national ADS-B system 220.

### III. Potential Applications and Use Cases

It should be noted that the examples listed throughout this section are issues for modern agriculture whether or not unmanned systems exist. What unmanned systems bring to the equation are efficiencies, access, and additional types of data. The ability to review and analyze richer data sets on each area in the field gives each plant in the field its best chance to reach its maximum potential for the given environmental and geographic conditions.

This is the very definition of “precision agriculture”: to give each plant the conditions and nutrients it needs to reach is maximum potential. Unmanned systems can help acquire the data faster, with higher frequency, and in a field's totality, rather than generalities made for the whole field derived from small samples.

### IV. Potential Use Cases Relating to Data Collection

Logical and user-friendly analytical software systems will be an essential part of any system offering. Assuming these software systems will be developed along with the appropriate sensor and data collection techniques, the following is a small list of potential applications and use cases for unmanned systems:
Visual scouting—high resolution aerial imagery
   Helps see entire field
   High resolution (better than 1 cm) could even show pest problems or damage
Infrared and near-infrared imaging—used to calculate a Normalized Difference Vegetative Index (NDVI) to assess crop health
Soil temperature
   Could potentially give recommendations on the best time to seed a particular crop
Insurance claim inspection
Soil moisture mapping
   Could also be used for predicting the right time to seed or when a field is not suitable to work
   Could be used for determining areas to install drain tile
   Could be used for prescription irrigation techniques
Grain/Crop moisture
   Could be used to assess ideal conditions for when to harvest a crop
General field mapping
   With the detection of changing field topography from year to year, new work paths could be visualized in different years to find the most efficient way to work the field
Disease detection and/or disease probability indicators
   A very broad problem with high return potential
      Modern practice generally tends to apply “broad spectrum” disease management techniques in order to minimize the risk of certain diseases
      If crops could be monitored with high enough frequency and with the right detection methodologies, crops may only be treated if it's absolutely necessary, resulting in very large savings potential
Livestock herd management
   Counting and tracking livestock in grazing situations
   Potentially assessing the health of individual herd members by body temperature
Soil nutrition
Crop density
   Could be used for pre-mapping the crop density of a field before harvest (for use in an automated combine)
   Could be used as an early indicator of yield (to help drive decisions on inputs throughout the year)
Crop readiness for harvesting
   Map a field by its ripeness
      Often, farmers guess at field readiness by checking one area of the field and, if it's ready, beginning to harvest, only to find out the field is much different further into the field
      This can have major implications on storage costs (if moisture is too high) and dockage potential at the elevator
      Could also be used in self-adjusting harvester techniques
Pre-harvest grain moisture detection
Thermal mapping
   Could be used to assess areas of stress
   Stressed crops can indicate disease or pests
   Can also drive irrigation
Multi-Spectral Imaging
   Generally used to assess crop health
Crop height
   Could be shown in a three-dimensional visualization
   Could be used to predict crop density and yield
Weed detection and management
Chemical spraying
   UAS have been used for this in Japan since the late 1980s
   Precision application of pesticide/herbicide only in areas where needed

Additional features and alternate embodiments are possible without deviating from the intent of the inventive concept described here. For example, many of the connections shown in FIGS. 1-3 as wireless may be successfully implemented using a direct wired connections, and those shown as direct wired connects would be successfully implemented using wireless connections. The figures show only one possible embodiment of the present invention, and are not meant to be limiting in any way.

The components shown in FIG. 1 for the AFCS are one possible configuration or embodiment. Other components may be used in addition to those shown, or in place of those shown. It is also possible to omit some of the components shown without deviating from the intent of the present invention as captured and claimed herein.

Having thus described the invention, what is claimed as new and desired to be secured by Letters Patent is:

1. An opt-out privacy management system for an unmanned aerial vehicle flight planning application, comprising:
an internet-based user input device;
an internet-based opt-out request management application;
an internet-based do-not-fly database application in communication with at least one existing, external aircraft safety system;
wherein a user can enter a property opt-out request into the user input device;
wherein the user input device sends the property opt-out request to the do-not-fly database application; and
wherein the do-not-fly database application communicates the property opt-out request to the at least one existing, external aircraft safety system, whereby the property opt-out request specifies that a specific piece of property be added to the do-not-fly database application to prevent unmanned aerial vehicles from flying over the specific piece of property.

2. The opt-out privacy management system for an unmanned aerial vehicle flight planning application of claim 1, wherein the at least one existing, external aircraft safety system is an air traffic control center.

3. The opt-out privacy management system for an unmanned aerial vehicle flight planning application of claim 1, wherein the at least one existing, external aircraft safety system is an ADS-B system.

4. The opt-out privacy management system for an unmanned aerial vehicle flight planning application of claim 1, further comprising an aerial information request system in communication with the do-not-fly database application, wherein the property opt-out request added to the do-not-fly database application can be made available to the aerial information request system, whereby the aerial information request system can use the property opt-out request in planning a new flight profile for an unmanned aerial vehicle.
